(19) United States
(12) Patent Application Publication
(10) Pub. No.: US 2012/0323462 A1
(43) Pub. Date: Dec. 20, 2012

(54) METHOD FOR OPERATING A DRIVE UNIT, AND CONTROL DEVICE FOR A DRIVE UNIT

(76) Inventors: Markus Henzler, Stuttgart (DE); Andreas Baier, Kornwestheim (DE)

(21) Appl. No.: 13/516,653

(22) PCT Filed: Nov. 15, 2010
(86) PCT No.: PCT/EP2010/067427

§ 371 Date: Aug. 28, 2012

(30) Foreign Application Priority Data
Dec. 18, 2009 (DE) 102009054945.5

(51) Int. Cl. F02D 28/00; B60L 15/20; G06F 17/00

(52) U.S. Cl. 701/102; 701/99

(57) ABSTRACT

A method for operating a drive unit having at least one drive machine which generates the torque supplied by the drive unit, a first parameter, which causes a slow change in the torque supplied by the drive unit, and a second parameter, which causes a rapid change of the torque, being used for setting a setpoint torque. Prior to raising the setpoint torque to a target torque, the first parameter is selected according to an actuating torque, which is greater than the setpoint torque; and the second parameter is selected in such a way that the drive unit continues to supply the setpoint torque. Furthermore, a control device for a drive unit is also described.

### FIELD OF THE INVENTION

The present invention relates to a method for operating a drive unit having at least one drive machine which generates the torque supplied by the drive unit; a first parameter, which causes a slow change in the torque supplied by the drive unit, and a second parameter, which causes a rapid change in the torque, being used for setting a setpoint torque. Furthermore, the present invention relates to a control device for a drive unit.

### BACKGROUND INFORMATION

Methods of the type described at the outset are discussed in the related art. For example, a specified torque is input by the driver of a vehicle via an accelerator pedal and the setpoint torque is selected accordingly. In order to improve the dynamic behavior of the drive unit or the drive machine, when reducing the setpoint torque relative to the specified torque the first and the second parameters are selected in such a way that they specify different values for the setpoint torque. The slow change of the torque is able to be brought about by the first parameter, and the rapid change, by the second parameter. In the reduction of the setpoint torque, the immediately requested setpoint torque is adjustable via the second parameter, while the first parameter is utilized to set the torque of the drive machine that is able to be achieved following the reduction, in particular immediately or after a short period of time. That is to say, the second parameter is utilized to reduce the torque to the setpoint torque, while the first parameter is used to select the torque that prevails following the reduction.

### SUMMARY OF THE INVENTION

In contrast, the present method having the features described herein has the advantage that the dynamic response of the drive unit is increased further.

### DETAILED DESCRIPTION

According to the exemplary embodiments and/or exemplary methods of the present invention, this is achieved in that, prior to increasing the setpoint torque to a target torque, the first parameter is selected in accordance with an actuating torque that is greater than the setpoint torque; and in that the second parameter is selected in such a way that the drive unit continues to supply the setpoint torque. In other words, the first and the second parameters are selected according to different torques of the drive unit. This is based on the basic principle that the desired actuating torque is specified by the first parameter, and a deviation from this actuating torque is achieved with the aid of the second parameter.

The dynamic response of the drive unit may then be increased by selecting the first parameter according to the actuating torque even before the setpoint torque is actually increased to the target torque. The actuating torque is greater than the instantaneous setpoint torque. At the same time, however, the currently generated torque, hereinafter denoted as instantaneous torque, of the drive unit is not to be increased yet, so that the second parameter is selected in such a way that the drive unit continues to output only the instantaneous torque instead of the actuating torque. The method is able to be used in an advantageous manner in particular if the target torque or the actuating torque is lower than a maximum torque of the drive unit or the drive machine.

The specified torque, and thus the setpoint torque, is input by the driver of the vehicle in which the drive unit may be provided, or it is input by a driver assistance device such as a Tempomat, for example. The drive machine is an Otto engine, for instance, but the method is able to be used to advantage also for other internal combustion engines such as Diesel engines. When increasing the setpoint torque to the target torque, this makes it possible to rapidly adjust the torque supplied by the drive, i.e., in a highly dynamic manner, to the greater setpoint torque (target torque).

It may be provided to select the first and/or second parameter in such a way that an optimization with regard to the operating state (temperature and the like), the emissions and/or the consumption of the drive unit is possible. In general, the objective consists of adjusting the first parameter to the actuating torque as early as required, but as late as possible. It must be ensured, in particular, that there is sufficient time for the drive unit or the drive machine to adjust to the first parameter, so that it is possible, via the modification of the second parameter, to rapidly adjust the output torque of the drive unit to the greater setpoint torque, i.e., the target torque, when increasing the setpoint torque.

In this context it must advantageously be taken into account that the adjustment of the first and the second parameter may possibly have a disadvantageous effect on the consumption and/or emissions of the drive unit in the manner already described. For this reason the first parameter should be set to the actuating torque as late as possible. The actuating torque need not necessarily (but may) correspond to the expected or desired setpoint torque following the increase, that is to say, to the target torque. Instead, it may be provided that the actuating torque is greater than the expected setpoint torque (target torque) after the increase. In this case, when the setpoint torque is increased to the target torque, it is first set with the aid of the second parameter, and the first and the second parameters are subsequently selected in such a way that the drive unit outputs the setpoint torque following the increase. In this way an even faster response of the drive unit is able to be achieved.

As an alternative, the drive machine is an electrical machine. The first parameter in this machine could correspond to a field-generating component of the current, and the second parameter could correspond to a torque-generating component.

When increasing the setpoint torque to the target torque, one further development of the present invention provides that the torque of the drive unit is set to the target torque with the aid of the second parameter. As mentioned earlier already, the first parameter thus is to be set according to the actuating torque. At the same time, the second parameter is selected in such a way that the drive unit continues to supply the current setpoint torque (instantaneous torque). If the setpoint torque is then to be increased to the target torque, the drive unit may be set to the target torque only with the aid of the second parameter. The first parameter remains at the value that had been selected according to the actuating torque prior to the increase in the setpoint torque. In other words, it is especially not the case that both the first and the second parameters are adjusted when increasing the setpoint torque. Only the second parameter is modified, until the drive unit has reached the target torque.

In one further refinement of the present invention, the difference between setpoint torque and actuating torque is less than or equal to a torque difference that is able to be compensated for with the aid of the second parameter. Starting from the current setpoint torque (instantaneous torque) of the drive unit, the actuating torque must thus not be selected in such a way that the instantaneous torque is no longer able to be maintained through a corresponding selection of the second parameter when adjusting the first parameter, which corresponds to the actuating torque. That is to say, the actuating torque may exceed the instantaneous torque by no more than the torque difference. Only then will it be ensured that the drive unit continues to output the instantaneous torque prior to increasing the setpoint torque.

In one further development of the present invention, the torque generated by the drive unit is set by the first parameter, and a counter-torque which counteracts the torque and is generated by an additional drive machine is set by the second parameter. The drive machine may be an internal combustion engine or an electrical machine, for instance, and the additional drive machine may likewise be an internal combustion engine or an electrical machine. A combination of internal combustion engine and electrical machine may be provided. The internal combustion engine is adjusted to the actuating torque with the aid of the first parameter, and the additional drive machine, which is in operative connection with the internal combustion engine, generates a counter-torque. The counter-torque counteracts the torque of the internal combustion engine, i.e., the actuating torque, so that the resulting torque that is output by the drive unit initially corresponds to the setpoint torque desired prior to the increase, i.e., the instantaneous torque.

One further development of the present invention provides that the drive machine is an internal combustion engine and that a throttle valve of the internal combustion engine is adjusted with the aid of the first parameter, and/or a shift in the ignition point is adjusted with the aid of the second parameter. This is provided for the Otto engine, in particular. In general, the internal combustion engine is operated without ignition point shift, i.e., at an optimal ignition point. This ensures low consumption and low emissions of the internal combustion engine. Prior to increasing the setpoint torque, the first parameter or the throttle valve of the internal combustion engine is then adjusted in such a way that it would generate the actuating torque at an ideal ignition point, i.e., without ignition point shift.

At the same time, the second parameter is used for selecting the ignition point shift that causes a reduction of the actuating torque to the currently prevailing setpoint torque (instantaneous torque). In other words, the internal combustion engine continues to generate the instantaneous torque prior to the increase. Since a modification of the ignition point shift manifests itself very rapidly in a change of the torque generated by the internal combustion engine, it is possible to use this parameter for the rapid increase or decrease of the generated torque. In contrast, a modification of the position of the throttle valve has a relatively slow effect.

According to one further development of the present invention, the ignition point shift is restricted to a maximum shift, and the maximum shift is selected in such a way that harmful emissions of the internal combustion engine are restricted to a value below a limit value and/or the ignition point shift is limited to a particular time span. Adjusting the ignition point via an appropriate selection of the ignition point shift or the second parameter has a negative influence on the pollutant emissions of the internal combustion engine, in particular. For this reason the second parameter is selected in such a way that the ignition point shift remains within a range in which the pollutant emissions, or the sum of all pollutant emissions, is less than the limit value. This is the reason for specifying the maximum shift that the ignition point shift or the second parameter may assume at most. Limiting the ignition point shift to the particular time span makes it possible to protect components. For example, overheating of an exhaust-gas purification device of the internal combustion engine, which may possibly occur as a result of the ignition point shift, is prevented in this manner.

In one further development of the present invention, the increase of the setpoint torque to the target torque and/or the target torque are/is determined in predictive manner. The expected setpoint torque is the setpoint torque or target torque that has come about following the increase. The expected setpoint torque (target torque) will usually correspond to the actuating torque, but it may also be the case that the actuating torque is greater than the target torque. Both the actual increase of the setpoint torque and its expected value, i.e., the target torque, may be determined in predictive manner. This means that the first and the second parameters are able to be adjusted accordingly even prior to the actual increase of the setpoint torque to the target torque.

In one further development of the present invention the increase of the setpoint torque to the target torque and/or the target torque are/is transmitted to the drive unit in predictive manner by a control and/or regulation unit, especially a driver assistance device, in this case, an ESP, ASR and/or ABS unit. Preparing the drive unit for the increase of the setpoint torque makes it possible to achieve improved dynamics (actuating dynamics). The control and/or regulation unit often already predictively determine(s) that the setpoint torque of the drive unit needs to be increased to the target torque. In this case this is transmitted to the drive unit even prior to the instant at which the actual increase of the setpoint torque is to take place. The setpoint torque is influenced by the ESP, ASR and/or ABS unit, in particular.

In these systems the setpoint torque or target torque that will most likely be required in order to achieve a particular intervention in the driving behavior of the vehicle to which the control and/or regulation device or the driver-assistance device is assigned, is specified as well. For example, an engine drag torque control DTC or a drive slip control that takes place especially above the torque specified by the driver is realizable at high actuating dynamics of the internal combustion engine. In the latter case, the dynamics of the drive unit are optimized, e.g., for a torque vectoring intervention with the aid of a brake device (DWT−B+PTC). The raising of the setpoint torque to the target torque and/or the expected target torque are/is transmitted to the drive unit via an additional interface quantity.

The transmission may take place via a CAN bus or a FlexRay bus. Such buses or bus systems are widely used in vehicles. The drive unit or drive machine is usually already provided with a connection for such a bus in order to be able to control or regulate the drive unit. Thus, it is advantageous if the transmission takes place via this bus as well.

In one further development of the present invention, the first parameter is maintained when the setpoint torque is reduced to the target torque, and the second parameter is selected in such a way that the drive unit supplies the target torque. In the reduction it is therefore to be ensured that a rapid increase in the torque supplied by the drive unit is possible thereafter. For this reason, the reduction is initially realized only by the second parameter, by selecting it in such a way that the target torque will be produced. The first parameter, on the other hand, is kept constant, so that the original setpoint torque (the instantaneous torque prior to the reduction) is rapidly obtainable again via the renewed modification of the second parameter.

This is advantageous in particular in interventions in the setpoint torque that are caused by the control and/or regulation unit or the driver-assistance device. These interventions are frequently of short duration, so that an immediate adjustment of the first parameter to the reduced setpoint torque (target torque) would result in reduced driving comfort of the vehicle. The torque set with the aid of the first parameter is usually no less than the torque set with the aid of the second parameter.

In addition, the exemplary embodiments and/or exemplary methods of the present invention relate to a control device for a drive unit having at least one drive machine which generates the torque supplied by the drive unit, especially for the purpose of executing the afore-described method; to adjust a setpoint torque, a first parameter is used, which causes a slow change in the torque supplied by the drive unit, and a second parameter is used, which causes a rapid change of the torque. The drive unit is provided to select, prior to increasing the actuating torque to a target torque, the first parameter according to a torque that is greater than the setpoint torque, and to select the second parameter in such a way that the drive unit continues to supply the setpoint torque. This allows the drive unit to have high torque dynamics.

1-10. (canceled)

11. A method for operating a drive unit, which includes at least one drive machine which generates the torque supplied by the drive unit, the method comprising:
adjusting a setpoint torque using a first parameter, which causes a slow change in the torque supplied by the drive unit, and a second parameter, which causes a rapid change of the torque; and
prior to increasing the setpoint torque to a target torque, selecting the first parameter according to an actuating torque that is greater than the setpoint torque and selecting the second parameter so that the drive unit continues to supply the setpoint torque.

12. The method of claim 11, wherein the torque of the drive unit is adjusted to the target torque with the aid of the second parameter when increasing the setpoint torque to the target torque.

13. The method of claim 11, wherein the difference between the setpoint torque and the actuating torque is smaller than or equal to a torque difference that is able to be compensated with the aid of the second parameter.

14. The method of claim 11, wherein the torque generated by the drive unit is adjusted with the aid of the first parameter, and a counter-torque, which is generated by an additional drive machine and counteracts the torque, is adjusted with the aid of the second parameter.

15. The method of claim 11, wherein the drive machine is an internal combustion engine, and a throttle valve of the internal combustion engine is adjusted with the aid of the first parameter, and/or a shift in the ignition point is adjusted with the aid of the second parameter.

16. The method of claim 11, wherein the ignition point shift is restricted to a maximum shift, and the maximum shift is selected in such a way that harmful emissions of the internal combustion engine lie below a limit value and/or the ignition point shift is limited to a particular time span.

17. The method of claim 11, wherein the increase of the setpoint torque to the target torque and/or the target torque are/is determined in predictive manner.

18. The method of claim 11, wherein the increase of the setpoint torque to the target torque, and/or the target torque are/is transmitted to the drive unit in predictive manner by a control and/or regulation unit.

19. The method of claim 11, wherein, when the setpoint torque is reduced, the first parameter is maintained and the second parameter is selected in such a way that the drive unit supplies the setpoint torque.

20. A control device for a drive unit having at least one drive machine, comprising:
an adjusting arrangement for adjusting a setpoint torque using a first parameter, which causes a slow change in the torque supplied by the drive unit, and a second parameter, which causes a rapid change of the torque;
wherein prior to increasing the setpoint torque to a target torque, the first parameter is selected according to an actuating torque that is greater than the setpoint torque and the second parameter is selected so that the drive unit continues to supply the setpoint torque.

21. The method of claim 11, wherein the increase of the setpoint torque to the target torque, and/or the target torque are/is transmitted to the drive unit in predictive manner by a control and/or regulation unit, which is a driver assistance device.

22. The method of claim 11, wherein the increase of the setpoint torque to the target torque, and/or the target torque are/is transmitted to the drive unit in predictive manner by a control and/or regulation unit, which is a driver assistance device that includes at least one of an ESP unit, an ASR unit and an ABS unit.
